(19) United States
(12) Patent Application Publication
(10) Pub. No.: US 2009/0015204 A1
(43) Pub. Date: Jan. 15, 2009

(54) Method and apparatus for managing operations associated with a backup power source at a network terminal

(75) Inventors: Jeffrey A. Rosenwald, Frederick, MD (US); Guy M. Merritt, Purcellville, VA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Tellabs Vienna, Inc., Naperville, IL (US)

(21) Appl. No.: 11/825,826

(22) Filed: Jul. 9, 2007

(51) Int. Cl. H02J 7/00

(52) U.S. Cl. 320/134

(57) ABSTRACT

A method and apparatus provide for managing operations associated with a backup power source at a network terminal. A network terminal includes a battery port that, when enabled, is configured to monitor status of a battery coupled to the battery port and provide a status indicator for the battery. The network terminal also includes an interface with selectable states. A control circuit detects the state of the interface and presence of a battery at the battery port. In response to the interface being in a given state in an absence of a battery coupled to the battery port, the control circuit causes the battery port to enter or remain in a disabled state. The battery port substantially maintains the disabled state over reset, loss of power and reconfiguration of the network terminal. If the battery port detects the presence of a battery, it responds by entering an enabled state to monitor the status of the battery and provide battery status indicators.

### BACKGROUND

A telecommunications network typically includes a number of network terminals, such as an optical network terminal (ONT), that provide a communications interface between subscriber terminals and an external network. The network terminals can be configured to support communications signals between the external network and corresponding subscriber terminals, as well as provide communications using Ethernet, Internet, fiber optics, or other communications protocols.

An optical network terminal is typically powered by an external power source, such as alternating current (AC) mains, but also includes a battery backup unit (BBU) for powering the unit in case of failure of the external power source. The optical network terminal monitors the BBU to ensure that the battery is present and sufficiently charged. If a battery is absent or not operational, the optical network terminal provides a battery alarm, indicating to a network operator or craft person a battery fault that can be resolved by repairing or replacing a battery at the optical network terminal.

### SUMMARY

Embodiments of the present invention provide a method or apparatus for managing operations associated with a backup power source at a network terminal. A network terminal may include a battery port that, when enabled, is configured to monitor status of a battery coupled to the battery port and provide a status indicator indicating presence or status of the battery. The network terminal also includes an interface with selectable states, such as a pushbutton or switch. Further, a control circuit is coupled to the battery port and interface to detect the state of the interface and presence of a battery at the battery port. In response to the interface being in a given state in an absence of a battery coupled to the battery port, the control circuit may be configured to disable reporting of information related to the battery. The battery port substantially continues to disable the reporting over reset, loss of power or reconfiguration of the network terminal. If the control circuit detects the presence of a battery at the battery port, it responds by entering an enabled state to monitor the status of the battery and provide battery status indicators.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a block diagram of a network communications system in which embodiments of the present invention may be implemented.

FIG. 2 is a block diagram of a network terminal having a battery management apparatus of the present invention.

FIG. 3A is a state diagram illustrating a method of battery management.

FIG. 3B is a state diagram illustrating a further method of battery management.

FIGS. 4A-4C are diagrams illustrating a network terminal at a number of states as configured according to embodiments of the present invention.

### DETAILED DESCRIPTION

A description of example embodiments of the invention follows.

A network terminal, such as an Optical Network Terminal (ONT), typically includes a battery backup unit (BBU) having a battery port and a battery. In some applications, a number of network terminals may be implemented at a central location, such as a common rack or enclosure. In such an implementation, a network terminal may not require a battery at the network terminal itself. For example, the network terminals may be powered by an external power supply unit that includes a battery backup unit (BBU), thereby providing backup power to the network terminals. Moreover, a particular application may not permit the network terminal to include a battery. The network terminals may, for example, be implemented in a way that prevents access to a battery, such as within a sealed enclosure. Without access to maintain a battery at the network terminal, use of a battery at the network terminal may be prohibited.

For the example reasons above, it may be beneficial to provide a network terminal without a battery. However, in the absence of a battery, the battery port or network terminal, depending on how intelligence is distributed, transmits a corresponding alarm (e.g., “loss of battery backup power” or “missing battery” alarms), which is unnecessary or erroneous in applications where the battery is intentionally omitted. In systems having a number of network terminals, the alarms may be problematic and detract from management of the system, for example by saturating a network administration console with such alarms. Further, the battery port may also be configured to charge a battery, and therefore may unnecessarily consume power in the absence of a battery.

Some embodiments of the present invention provide a method or apparatus for managing operations associated with a backup power source at a network terminal. A network terminal may include a battery port that, when enabled, is configured to monitor status of a battery coupled to the battery port and provide a status indicator for the battery. The network terminal also includes an interface with selectable states, such as a pushbutton or switch. Further, a control circuit is coupled to the battery port and interface to detect a state of the interface and presence of a battery at the battery port. In response to the interface being in a given state in an absence of a battery coupled to the battery port, the control circuit may disable reporting of information related to the battery. Likewise, the control circuit may cause the battery port to enter or remain in a disabled state with respect to reporting information related to the battery or other operations. The battery port substantially continues to disable the reporting (and, optionally, maintain the disabled state) over reset, loss of power, or reconfiguration of the network terminal. If the control circuit detects the presence of a battery, it responds by entering an enabled state to monitor the status of the battery and provide battery status indicators.

In further embodiments of the invention, the battery port may include a battery charger and battery status monitor. The battery status monitor may detect presence and power level of a battery and provide alarms in response to detecting the absence of a battery or low power level of a battery. The control circuit may also cause the battery port to enter a disabled state in response to the interface being in a given state in the absence of a battery connected to the battery port. Such a disabled state may include disabling the battery charger and alarms while continuing to detect the presence of a battery. The control circuit may also be configured to refrain from disabling the reporting in response to detecting presence of a battery at the battery port.

Embodiments of the invention may include an interface, such as a pushbutton, that maintains the active state when pushed continuously, and is inactive when not pushed. The control circuit may provide an audible indication upon disabling or enabling reporting of information related to the battery. A configuration associated with the disabled state may be stored to a non-volatile memory such that the configuration can be maintained over reconfiguration, reset, or loss of power to the network terminal. The control circuit may modify the configuration in response to detecting a battery at the battery port.

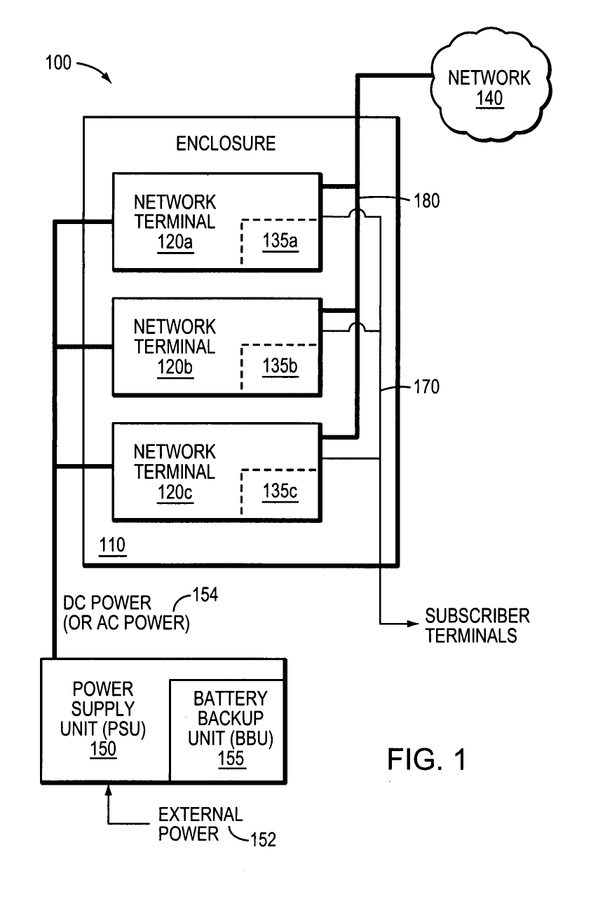

FIG. 1 is a network diagram illustrating a network communications system 100 in which embodiments of the present invention may be implemented. A plurality of network terminals 120a-c are configured at an enclosure 110. The enclosure 110 may include a rack or other structure (not shown) to support the network terminals 120a-c, as well as other network equipment. Each of the network terminals 120a-c connects to an external network 140 via an external network channel 180, which can be an Ethernet, fiber optic or other compatible channel (not shown). The network terminals 120a-c further connect, via subscriber lines 170 (Ethernet, fiber optic, or other channel), to one or more subscriber terminals (not shown). Thus, the network terminals 120a-c as configured provide an interface for communications between the subscriber terminals and the network 140 by supporting communications signals. It should be understood that the network terminals 120a-c may not be arranged in the enclosure 110 in other network configurations, such as in a more distributed network arrangement.

The network terminals 120a-c may be monitored and controlled by a network administrator console (not shown), which may communicate with the terminals 120a-c across the network 140, via subscriber lines 170, or other communications path (not shown). The network administrator console may monitor the status of each terminal 120a-c by receiving alarms and other status indicators, as well as configure and control each terminal 120a-c.

In this example network, the network terminals 120a-c are powered by a common power supply unit (PSU) 150. The PSU 150 receives external power 152 from an external power source, such as line power, and may provide direct current (DC) 154, or alternating current (AC) power if the network terminals 120a-c are equipped with AC-to-DC converters, to the network terminals 120a-c. The PSU 150 also includes a battery backup unit (BBU) 155, which the PSU 150 may manage and utilize for power in circumstances where external power (e.g., 120V AC) is lost. Likewise, the network terminals 120a-c each have a battery slot 135a-c for receiving batteries (not shown) at the network terminals 120a-c. Yet because the PSU 150 includes the battery backup unit 155, batteries or BBUs are not included at the network terminals 120a-c.

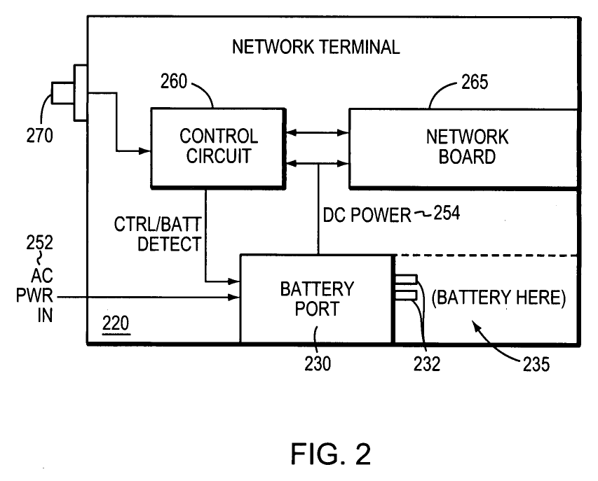

FIG. 2 illustrates a network terminal 220 providing battery management, which may be employed as one or more of the network terminals 120a-c in the network communications system 100 of FIG. 1. The network terminal 220 includes a network board 265 for routing network communications, battery port 230, and control circuit 260. A battery port 230 is configured to receive a battery (not shown) at a battery slot 235, coupling to the battery via a battery connector 232 to electronics, such as the control circuit, in the network terminal 220. The battery port 230 also receives external power, via a DC or AC input 252, from an external power source, such as the PSU 150 of FIG. 1.

In normal operation, the battery port 230 converts AC power 252 from the external power source to provide DC power 254 to the control circuit 260 and the network board 265. If the external power 252 is interrupted or sufficiently attenuated, then the battery port 230 may instead draw power from a battery at the battery slot 235. However, in some implementations, the battery port 230 may receive an external power source having a battery backup, such as the PSU 150 with battery backup 155 shown in FIG. 1. In some applications, such an external power source may be sufficiently reliable to power the network terminal 220 without a secondary power source. Accordingly, a battery may be omitted from the battery slot 235, as shown.

Moreover, other applications may require omitting a battery from the network terminal 220. With reference to FIG. 1, for example, the network terminal 220 may be configured in an enclosure 110 with a plurality of other network terminals 120a-c, where the enclosure 110 is sealed within a room or otherwise difficult to access. Other example reasons in which batteries to support battery backup operations may not be possible or are prohibited may be due to environmental risk, fire hazard or other concern, for both enclosure 110 and non-enclosure deployments of network terminals. Thus, the network terminal 220 may be configured without a battery.

Omitting a battery at the network terminal 220, however, may have a number of adverse effects. In normal operation, in at least one example implementation, the battery port 230 is configured to detect the presence and charge level of a battery at the battery slot 235. If the battery is omitted as shown, the battery port 230 may transmit a “no battery” alarm or message to the control circuit 260 or network board 265, which may be directed or forwarded to a network administrator console (not shown) to notify a network administrator or craft person. This alarm or message, being a false alarm or message in a sense that the network terminal 220 is intentionally configured without a battery, may detract from network administration. In an application with several network terminals transmitting a “no battery” alarm or message (e.g., network terminals 120a-c in FIG. 1), the detrimental effect of these alarms or messages is multiplied, perhaps to an extent of saturating communications at the network administrator console with the false alarms or messages. Further, the battery port 230 may be configured to charge a battery coupled to it. Without a coupled battery, the battery port 230 may still draw nominal current (for example, to an internal battery charger (not shown)) for the purpose of charging a battery. Because no battery is present to be charged, this current draw is unnecessary and may reduce efficiency of the network terminal 220 due to extraneous power consumption.

According to an example embodiment of the invention, the control circuit 260 addresses problems, as described above, occurring in configurations in which the network terminal 220 is intentionally operating without a battery at the battery slot 235. The control circuit 260 receives the state of an interface 270, such as a pushbutton 270, which may be mechanically accessible from outside the network terminal 220 or via a wired, wireless or optical interface (not shown) configured in any number of ways to accept craft person or user input as known in the art. The control circuit 260 may also receive, from the battery port 230, an indication of whether a battery is coupled to the battery port 230. The network board 265 may also communicate with the control circuit 260, indicating operational status of the network terminal 220. Based on the interface (e.g., pushbutton) 270 state, battery status and operational status, the control circuit 260 may configure or reset the configuration of the battery port 230. For example, the control circuit 260 can be configured (i.e., learn that the network terminal 220 is to operate without a battery intentionally) such that, if 1) the network terminal 220 is initializing, 2) the pushbutton is depressed for a given length of time during the initializing, and 3) a battery is not present at the battery port, then the control circuit 260 configures the battery port 230 to enter a disabled state so that it doesn't generate alarms or messages that a battery is not connected to it. It should be understood that other sequences of operations or direct configurations may also be defined to “teach” the control circuit 260 (or other circuit used for this purpose) that the network terminal 220 is to operate without a battery connected to its battery port 230.

In a disabled state, one or more functions of the battery port 230 may be disabled, including, for example, the disabling or silencing of battery-related alarms or messages and the disabling of an integral battery charger. Other functions or circuitry of the battery port 230, particularly those that are unused or redundant in the absence of a battery, may also be disabled in the disabled state. However, the battery port 230 in a disabled state may still perform other functions, including routing external power to other components of the network terminal 220, converting the external power as required by the network terminal 220 (e.g., AC-to-DC conversion), monitoring the external power, monitoring the presence of a battery, and communicating with the network board 265 and control circuit 270. Alternatively, one or more of the above functions may be performed by circuitry external from the battery port 230, such as by the control circuit 260 or network board 265.

Once the battery port 230 or control circuit 260 has entered the disabled state with respect to battery alarms, messaging, charging or other battery-related activities, it maintains the disabled state until a given event occurs. For example, the battery port 230 can terminate the disabled state, thereby entering an enabled state, upon detecting a battery being connected to the battery port 230. In the enabled state, the battery port 230 may resume normal operation, including monitoring the presence and charge level of the battery, charging the battery, and communicating battery status, alarms, or messages to the control circuit 260 or other module. However, the battery port 230 may be configured to maintain the disabled state until the given event (e.g., detecting a battery), regardless of other events that occur. For example, the disabled state may be maintained over reset, loss of power, reconfiguration of the network terminal, and/or other events affecting the battery port 230. To maintain the disabled state through such events, the battery port 230 may include a non-volatile memory or other storage device (not shown) to store an indication of the disabled state, to which the battery port 230 or control circuit 260 can refer. Thus, the battery port 230 may be considered to enter the disabled state on a substantially permanent or semi-permanent basis.

It should be understood that the example embodiment may include a distributed or centralized intelligence and that more, or fewer, or combinations of the blocks (e.g., control circuit 260 and battery port 230) may be combined physically or logically. For example, the control circuit may be disabled with respect to generating or sending alarms or messages to other units, or the battery port may be disabled from generating the alarms or messages. Alternatively, the battery port may not be so disabled but the control circuit 260 filters the alarms or messages from being sent to another device or presented as an audible alarm. For readability, other descriptions herein may refer to the battery port 230 as being disabled from generating alarms or messages in an event no battery is connected to it, but it should be understood that the control circuit 260 or other circuits may instead or in addition be disabled and enabled, as described herein.

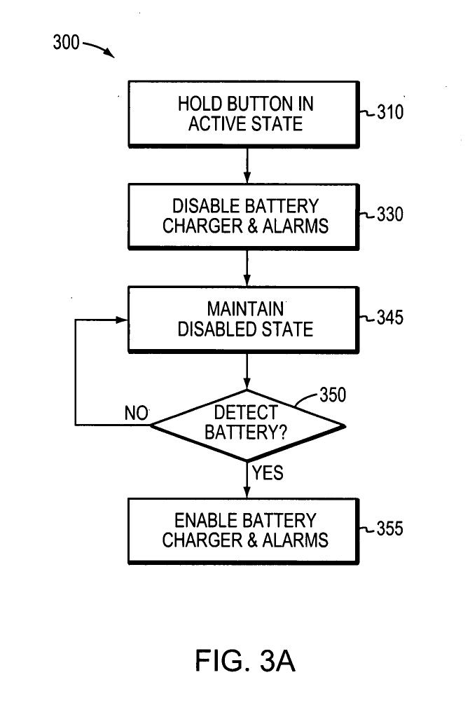

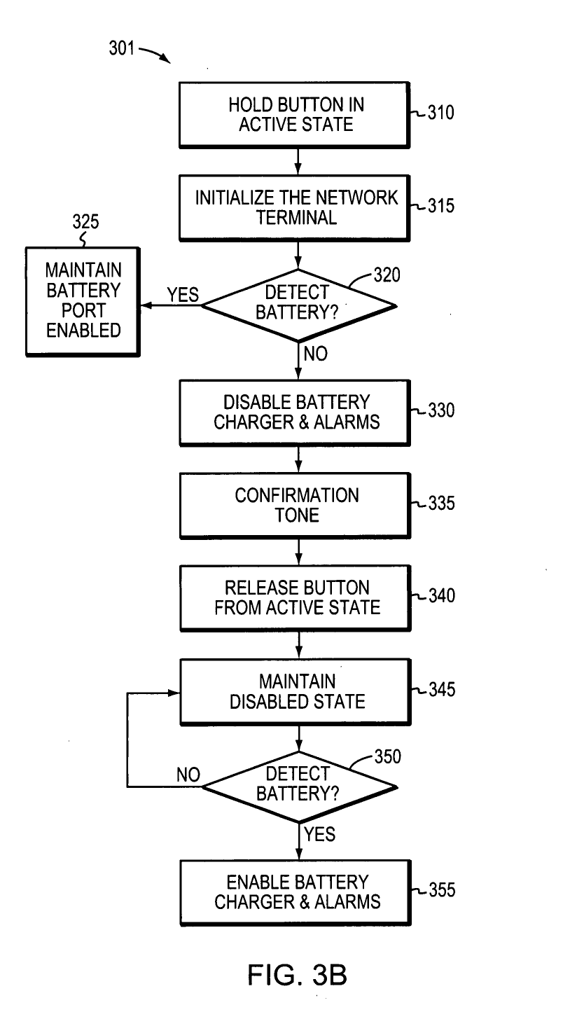

FIG. 3A is a state diagram of an example process 300 of configuring a disabled state of a battery port at a network terminal, such as the network terminals 120a-c and 220 of FIGS. 1 and 2. With reference to FIGS. 2 and 3A, a user holds the pushbutton 270 in an active (depressed) state (310). The control circuit 260, in response to the active state and other status of the network terminal 220, causes the battery port 230 to disable one or more of the battery charger, alarms or messages, and other functions at the battery port 230 (330). The battery port 230 may therefore be considered to be in a disabled state. The battery port 230 may maintain the disabled state through reset, reconfiguration, and loss of power to the network terminal 220 (345). While maintaining the disabled state, the battery port 230 continuously, periodically, or aperiodically tests for the presence of a battery being connected to the battery port 230 (350). Alternatively, the battery port 230 may check for the presence of a battery when prompted by a user or external signal.

If a battery is not detected at the battery port 230, then the battery port 230 continues to maintain a disabled state (345). If the battery port 230 detects a battery, then it enables the battery charger, alarms and other functions disabled while in the disabled state (355). Thus, the battery port 230 may be considered to terminate the disabled state upon detecting a battery. The battery port 230 may terminate the disabled state independent of the control circuit 260 or network board 265, or may report the presence of a battery to the control circuit 260, which, in turn, controls the battery port 230 to terminate the disabled state.

FIG. 3B is a state diagram of a further example process 301 of configuring a disabled state of a battery port at a network terminal, such as the network terminals 120a-c and 220 of FIGS. 1 and 2. The process 301 may include one or more of the states of the process 300 described above with reference to FIG. 3A.

With reference to FIGS. 1 and 2 and FIG. 3B, the process 301 may be initiated during installation or configuration of a network terminal 120a-c, 220 within an enclosure 110 or other architecture. Before or during power-up or initialization of the network terminal 220, a user holds the pushbutton 270 in an active state (310). Holding the pushbutton 270 in the active state may require being maintained through initialization of the network terminal 220 (315), or for a given length of time, depending on programming, circuitry, or other implementations to detect a user or craftsperson to operate in a “no battery” mode. During initialization, the battery port 230 detects whether a battery is coupled to it (320). If a battery is detected, the battery port 230 is configured or controlled to refrain from entering a disabled state, thereby entering or maintaining normal battery port operation in an enabled state (325).

For reasons described above, a battery may be omitted from the network terminal 220. In such a case, the battery port 230 fails to detect a battery during power-up (or other state detection of a battery is checked in connection with the battery or non-battery configuration). Under normal operation, the battery port 230 may respond to the absence of a battery by emitting an alarm or other indicator, which may be audible, visual, or transmitted through the network board 265 to notify a network administrator. However, in response to the pushbutton 270 being held in an active state during initialization, the control circuit 260 controls the battery port 230 to disable one or more battery-related functions, such as network alarms, audible alarms, or the battery charger (330). The battery port 230 thus enters a disabled state. Upon entering the disabled state, the battery port 230 or other circuit may emit a confirmation tone or other cue to indicate the disabled state (335). Upon hearing the confirmation tone, the user or craft person may release the pushbutton 270 from the active state (340). The user or craft person has thus completed configuring the network terminal 220 to operate in the absence of a battery, disabling one or more functions of the battery port 230.

Once the battery port 230 enters the disabled state under the above process, it may maintain the disabled state on a substantially permanent or semi-permanent basis (345). The battery port 230 may maintain the disabled state independently via an internal configuration or control, or may be controlled continuously, periodically, or aperiodically by the control circuit 260 to maintain the disabled state. Data indicating the disabled state configuration may be stored to non-volatile memory (not shown) at the network terminal 220. The battery port 230 or control circuit 260 may refer to this data in maintaining the disabled state. As a result, the battery port 230 may maintain the disabled state through reset, reconfiguration and loss of power to the network terminal 220.

While maintaining the disabled state, the battery port 230 detects for the presence of a battery being coupled to the battery port 230 (350). If no battery is detected, the battery port 230 continues to maintain the disabled state, and further detects for a battery periodically, continuously, or when prompted to do so (350).

In some applications, after operating without an internal battery backup, the network terminal 220 may require a battery to be coupled to the battery port 230. Thus, a user may install a battery at the battery slot 235 while the battery port 230 is in a disabled state. In response, the battery port 230 detects the battery and may send a battery detection indicator to the control circuit 260. The control circuit then controls the battery port to enter an enabled state, enabling one or more of the battery charger, alarms or other functions disabled in the disabled state (355). Alternatively, the battery port 230 may respond to detecting the battery by entering the enabled state independently from the control circuit 260. By terminating the disabled state, the battery port 230 enters normal operation with respect to the battery, for example detecting charge level of the battery, charging the battery, and indicating status and alarms relative to the battery.

Alternatively, the network terminal 220 can be configured to enter an enabled state under other conditions. For example, the disabled state of the battery port 230 may be configured such that it is not maintained following one or more of the following conditions: reconfiguration, reset or loss of power to the network terminal. Moreover, an additional user interface (not shown), such as a pushbutton or switch, may enable a user to terminate manually the disabled state of the battery port 230. In a further embodiment employing such a user interface, the battery port 230 may also disable battery detection while in the disabled state. Thus, with reference to FIG. 3B, the battery port 230 in this embodiment may not detect a battery (350), instead entering the enabled state (355) in response to the user interface (not shown). A user may utilize this interface to enable the battery port 230 after inserting a battery at the battery slot 235 of the network terminal 220, removing and reinstalling the network terminal 220 in a different environment, or for other reasons.

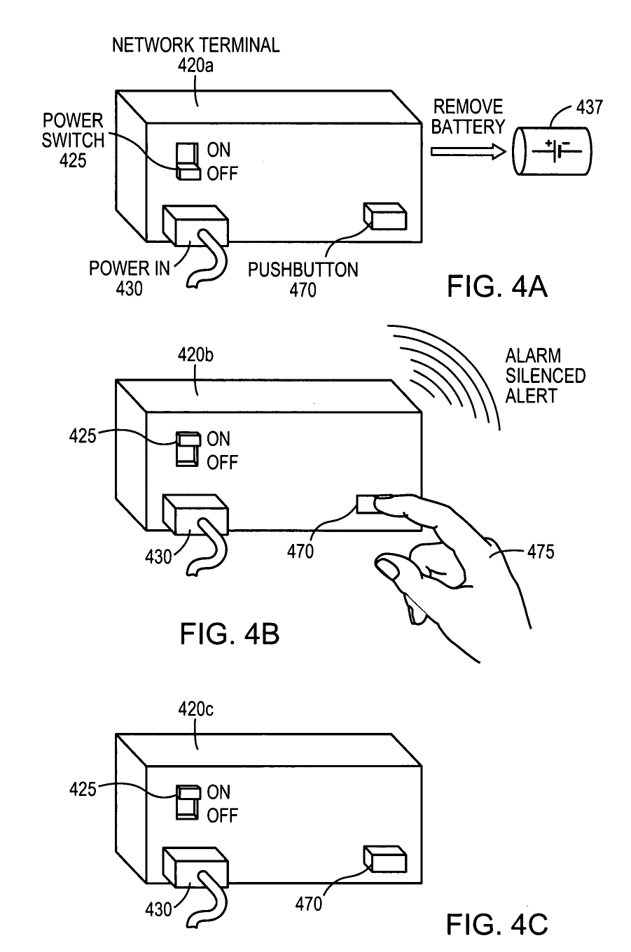

FIGS. 4A-4C illustrate a network terminal 420a-c in states of configuration in a further example embodiment of the invention. The network terminal 420a-c may be configured to include features of the network terminals 120a-c, 220 described above with reference to FIGS. 1 and 2. In addition, the network terminal 420a-c may be configured to perform functions described above with respect to the processes 300, 301 in FIGS. 3A-B.

In FIG. 4A, the network terminal 420a is connected to receive power via the power input 430, but is unpowered, as indicated by the power switch 425 being “off.” A pushbutton 470 may be configured as the pushbutton 270 described above with reference to FIGS. 2, 3A and 3B. The network terminal 420a may include a battery 437 installed to provide backup power in a default configuration. The battery 437 is removed prior to initializing the network terminal 420a. For example, a user may install the network terminal 420a in a “non-battery friendly” operating environment, and remove the battery before initializing the network terminal 420a.

In FIG. 4B, the network terminal 420b is shown at a later state of configuration during a process of initialization. The network terminal 420b may correspond to states of configuration described above. With reference to FIG. 3B, for example, a user 475 holds the pushbutton 470 in an active state (310) and begins the initialization of the network terminal 420 by turning the power switch 425 ON (315). Because the battery 437 was previously removed, a battery is not detected (320), and the network terminal 420 enters a disabled state by disabling the battery charger, battery alarms and/or other functions (330). Upon entering the disabled state, the network terminal 420b emits a confirmation or “alarm silenced” tone as shown (335). This tone indicates that the disabled state has been entered and that the user 475 may release the pushbutton 470 from the active state.

In FIG. 4C, the network terminal 420c is shown subsequent to that in FIG. 4B, where the user 475 has released the pushbutton from the active state (340), and the network terminal 420c maintains the disabled state on a substantially or semi-permanent basis (345). A process of configuring the network terminal 420a-c as shown in FIGS. 4A-C may include further aspects or elements as described above with reference to the processes 300, 301 described above with reference to FIGS. 3A-B.

While this invention has been particularly shown and described with references to example embodiments thereof, it will be understood by those skilled in the art that various changes in form and details may be made therein without departing from the scope of the invention encompassed by the appended claims.

It should be understood that the flow diagrams of FIGS. 3A and 3B may be implemented in hardware, firmware, or software. If implemented in software, the software may be written in any language suitable to perform the operations described herein, stored as machine-readable instructions on any machine-readable medium, such as RAM, ROM, or CD-ROM, loaded and executed by any form of computer processor, such as general purpose or application specific, that can be configured with software to perform the operations described herein. The control circuit, network board, and battery port of FIG. 2 are high-level examples of such computer processors if implemented in a form to load and execute software.

What is claimed is:

1. An apparatus for managing operations associated with a backup power source at a network terminal, the apparatus comprising:
a battery port at a network terminal configured, in an enabled state, to monitor status of a battery and provide a status indicator indicating presence or status of the battery;
an interface at the network terminal having selectable states; and
a control circuit coupled to the interface and the battery port and, in response to the interface being in a given state in an absence of the battery coupled to the battery port, the control circuit is configured to disable reporting of information related to the battery and substantially continue to disable the reporting over reset, loss of power or reconfiguration of the network terminal and, in response to detecting presence of a battery at the battery port, the control circuit is further configured to enable the reporting.

2. The apparatus of claim 1 wherein the battery port includes a battery charger and a battery status monitor, the battery status monitor operable to detect presence and power level of a battery and provide alarms in response to detecting one of absence of a battery and low power level of a battery.

3. The apparatus of claim 1, wherein the control circuit is configured to cause the battery port to enter a disabled state in response to the interface being in the given state in the absence of the battery coupled to the battery port.

4. The apparatus of claim 3 wherein the battery port in the disabled state is configured to disable the battery charger and alarms.

5. The apparatus of claim 4 wherein the battery port in the disabled state is configured to detect the presence of a battery.

6. The apparatus of claim 1 wherein the control circuit is configured to refrain from disabling the reporting in response to detecting presence of a battery.

7. The apparatus of claim 1, wherein the user interface is a pushbutton.

8. The apparatus of claim 7, wherein the pushbutton maintains the active state when pushed continuously, and is inactive when not pushed, and wherein the given state is the active state.

9. The apparatus of claim 1, wherein the control circuit is configured to provide an audible indication at least in an event the control circuit disables the reporting.

10. The apparatus of claim 1, further comprising a non-volatile memory to store a configuration associated with the control circuit disabling the reporting.

11. The apparatus of claim 10, wherein the control circuit is configured to modify the configuration in response to detecting a battery at the battery port.

12. A method of managing operations associated with a battery at a network terminal, the method comprising:
monitoring a selectable state of an interface at a network terminal;
determining a presence or absence of a battery at the network terminal;
disabling reporting of information related to the battery, in response to the absence of the battery and the state of the interface, over reset, loss of power or reconfiguration of the network terminal;
monitoring the presence of a battery at the battery port; and
enabling reporting of information related to the battery in response to detecting the presence of a battery at the battery terminal.

13. The method of claim 12 wherein the reporting of information includes reporting at least one of battery status, battery presence and battery power level, the reporting including providing an alarm or message corresponding to the reporting.

14. The method of claim 12 further comprising disabling charging of a battery in response to the absence of the battery and the state of the interface.

15. The method of claim 12 wherein the monitoring is performed during initialization of the network terminal.

16. The method of claim 15 further comprising preventing disabling the reporting in response to detecting presence of a battery during the initialization.

17. The method of claim 12 wherein disabling reporting of information includes determining a state of a pushbutton configured to be the interface.

18. The method of claim 17 wherein the disabling is performed in response to the pushbutton being maintained in an active state in the absence of the battery, the pushbutton being in the active state when pushed.

19. The method of claim 12 further comprising providing an audible indication at least when the disabled state is entered.

20. The method of claim 12 further comprising storing a configuration associated with the a disabled state to a non-volatile memory.

21. The method of claim 20 further comprising modifying the configuration in response to detecting a battery at the battery port.

22. A computer program product having processor-readable instructions stored thereon, the processor-readable instructions, when loaded and executed by a processor, cause the processor to:
monitor a selectable state of an interface at a network terminal;
determine a presence or absence of a battery at the network terminal;
disable reporting of information related to the battery, in response to the absence of the battery and the state of the interface, over reset, loss of power or reconfiguration of the network terminal;
monitor the presence of a battery at the battery port; and
enable reporting of information related to the battery in response to detecting the presence of a battery at the battery terminal.
